(19) United States
(12) Patent Application Publication
(10) Pub. No.: US 2003/0004222 A1
(43) Pub. Date: Jan. 2, 2003

(54) Photocurable resin composition and plastic sheet

(76) Inventors: Takayoshi Tanabe, Tsukuba Ibaraki (JP); Atsuya Takahashi, Tsuchiuri-shi (JP); Yuichi Takehana, Yokkaichi (JP); Takashi Ukachi, Ushiku (JP)

Correspondence Address: PILLSBURY WINTHROP, LLP, P.O. BOX 10500, MCLEAN, VA, 22102, US

(21) Appl. No.: 10/126,948

(22) Filed: Apr. 22, 2002

Related U.S. Application Data
(63) Continuation of application No. PCT/NL00/00744, filed on Oct. 16, 2000.

(30) Foreign Application Priority Data
Oct. 22, 1999 (JP) 1999-301056
Oct. 22, 1999 (JP) 11/301056

(51) Int. Cl. C08F 2/46; C08J 3/28; B32B 27/36

(52) U.S. Cl. 522/100; 522/181; 522/182; 428/412

(57) ABSTRACT

Subject

A photocurable resin composition suitable for forming a cured film on a plastic substrate, wherein the cured film obtainable by photocuring the photocurable resin composition has a refractive index between 1,56 and 1,65 and a plastic sheet coated by the cured coating of the photocurable resin composition are provided.

Effect

A stain-proof and damage-proof plastic sheet without interference fringes can be obtained by using the composition. Such a plastic sheet is useful as an exterior material for ornamental panels and furniture, and as a backlight optical material for liquid display devices as a plastic lens sheet exhibiting high luminance without change in color.

### FIELD OF THE INVENTION

The present invention relates to a photocurable resin composition and a plastic sheet having a surface coated by cured coating of the photocurable resin composition.

### PRIOR ART

In recent years, interior materials for houses, particularly ornamental panels for doors, walls, and ceilings, as well as exterior materials for furniture, are gaining value in terms of design, the function of preventing adherence of stains, high gloss, and the like. Paint or varnish has conventionally been used for preventing stains from adhering or for imparting gloss to the surface of panels and furniture However, applying paint or varnish requires solvents which not only affect the work environment and health of workers, but also decrease work efficiency. Development of an alternative technology has therefore been desired In recent years a technology of attaching plastic sheets of polyethylene terephthalate or polycarbonate as exterior materials has been used as a method of providing gloss and increasing design value with good work efficiency without using a solvent. However, although plastic sheets provide good work efficiency, excellent gloss, the plastic sheets usually lack satisfactional prevention of stain adherence, surface hardness and are easily damaged.

More recently, a technology of applying a photo-curable resin coating to plastic sheets such as polystyrene sheets, styrene-methyl methacrylate copolymer sheets, polyethylene terephthalate sheets, or polycarbonate sheets to provide a lens configuration has been developed. Such plastic sheets are used as prism lens sheets to increase the luminance of a liquid crystal display or used as Frensel lens for projection TVs.

### PROBLEMS TO BE SOLVED BY THE INVENTION

One method attempted to overcome the above problem was applying a UV curable resin composition to plastic sheets and curing the composition to produce a coating which prevents the plastic sheet surface from being stained and damaged. However, conventional photocurable resin compositions produce optical interference fringes (irises) on the plastic sheets after application and curing, impairing the appearance and decreasing the design value. No satisfactory technology has as yet been developed.

In addition, when a plastic sheet is provided with a lens configuration using a photocurable resin composition, a decrease in luminance and change in color due to reflection may occur at the interface of the plastic sheet and the coating material if their refractive indexes greatly differ.

Therefore, an object of the present invention is to provide a photocurable resin composition exhibiting stain-proof and damage-proof functions without producing optical interference fringes when coated on the surfaces of plastic sheets such as polystyrene, styrene-methyl methacrylate copolymer, polyethylene terephthalate, and polycarbonate. Another object of the present invention is to provide a plastic sheet suitable as an exterior material for ornamental panels and furniture, and a plastic lens sheet exhibiting high luminance without change in color, using the photocurable resin composition.

### MEANS FOR SOLVING THE PROBLEMS

The present inventors have conducted extensive studies relative to the cause of interference fringes produced when a conventional photocurable resin composition is coated on a plastic sheet made from polystyrene, styrene-methyl methacrylate copolymer, polyethylene terephthalate, polycarbonate, or the like. As a result, the inventors have found that the interference fringes are caused by the difference in the refractive index of the plastic sheet and that of the coating material, and that the surface of the plastic sheet can be coated without causing interference fringes if the refractive index of the coating material is between 1.56 and 1.65. The inventors have further found that such a coating can provide a plastic sheet suitable as a stain/damage proof interior construction material for houses, particularly ornamental panels for doors, walls, and ceilings, as well as exterior materials for furniture, with a target design value, or a plastic lens sheet suitable for use as a prism lens sheet or a Fresnel lens sheet with high luminance and less change in color. Such findings led to the completion of the present invention.

The problems of the prior art have been solved by applying a photocurable resin composition suitable for forming a cured film on a plastic substrate, wherein the cured film obtainable by photocuring the photocurable resin composition has a refractive index between 1,56 and 1,65.

The present invention further provides a plastic sheet having a surface coated with a cured coating of the photocurable resin composition

### PREFERRED EMBODIMENT OF THE INVENTION

Preferably the photocurable resin composition comprises a component (A) which is chosen from a group comprising components having two (meth)acrylate groups and a divalent group shown by the following formula (1),

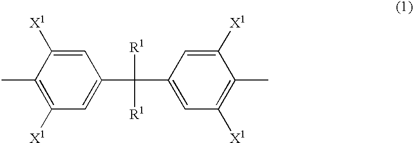

wherein R¹ independently represents a hydrogen atom or a methyl group, and X¹ independently represents a hydrogen atom, chlorine atom, or bromine atom, with the proviso that at least one X¹ is chlorine or bromine; and components having a (meth)acrylate group and a group shown by the following formula (2),

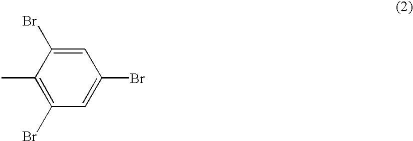

Even more preferred are photocurable resin compositions having a component (A) that is at least one compound selected from a group consisting of the compound represented by the following formula (1a),

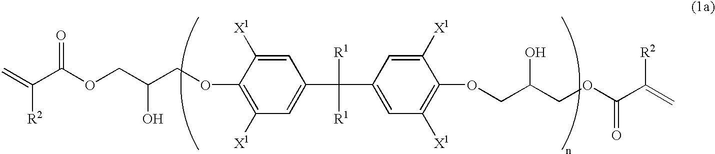

wherein R¹ and R² independently represent a hydrogen atom or a methyl group, n is an integer from 1 to 6, and X¹ independently represents a hydrogen atom, chlorine atom, or bromine atom with the proviso that at least one X¹ is chlorine or bromine; the compound represented by the following formula (1b),

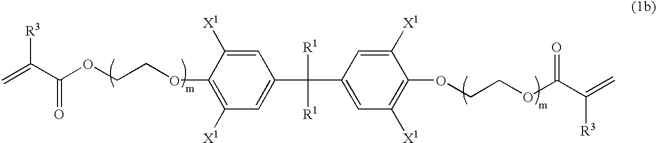

wherein R¹ and R³ independently represent a hydrogen atom or a methyl group, m is independently an integer from 1 to 6, and X¹ independently represents a hydrogen atom, chlorine atom, or bromine atom with the proviso that at least one X¹ is chlorine or bromine, and the compound represented by the following formula (2a),

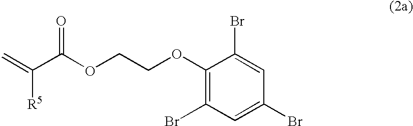

wherein R⁵ represents a hydrogen atom or methyl group.

Preferred examples of the di(meth)acrylate of the above formula (1a) are compounds having a methyl group for R¹, a hydrogen atom for R², an integer from 1 to 6 for n, and a hydrogen atom for X¹; and a compound having a methyl group for R¹, a hydrogen atom for R², an integer from 1 to 6 for n, and a bromine atom for X¹.

Examples of the di(meth)acrylate of the formula (1a) are compounds obtained by the reaction of bisphenol A and glycidyl ether followed by the addition of acrylic acid or methacrylic acid; and a compound obtained by the reaction of tetrabromobisphenol A and glycidyl ether followed by the addition of acrylic acid or methacrylic acid.

As commercially available products, Epoxy Ester 3000M, Epoxy Ester 3000A, Epoxy Ester EH-1001, Epoxy Ester ES 4004 (manufactured by Kyoeisha Chemical Co., Ltd.), Neopole 8100, Neopole 8250, Neopole 8190, Neopole AC5702 (manufactured by Japan Yupica Co., Ltd.), V540 (manufactured by Osaka Organic Chemical Industry, Ltd.), Ripoxy VR-77, VR-60, VR-90 (manufactured by Showa High Polymer Co., Ltd.), and the like can be given.

Preferred examples of the di(meth)acrylate of the above formula (1b) are compounds having a methyl group for R¹, a hydrogen atom for R³, an integer from 1 to 6 for m, and a hydrogen atom for X¹; and a compound having a methyl group for R¹, a hydrogen atom for R³, an integer from 1 to 6 for m, and a bromine atom for X¹.

Specifically preferred examples of the compound of the formula (1b) are compounds obtained by the addition of acrylic acid or methacrylic acid to polyoxyalkylene bisphenol A and compound obtained by the addition of acrylic acid or methacrylic acid to polyoxyalkylene tetrabromobisphenol A.

As commercially available compounds, Viscoate #700 (manufactured by Osaka Organic Chemical Inudstry, Ltd.), Light Acrylate BP-4EA (manufactured by Kyoeisha Chemical Co., Ltd.), Kayarad R-55 1, SR-349, SR-601, SR-602 (manufactured by Nippon Kayaku Co., Ltd.J), BR-42m (manufactured by Dai-ichi Kogyo Seiyaku Co., Ltd.), Aronix M-206, M-210 (manufactured by Toagosei Co., Ltd.), NK Ester BPE-100, BPE-200, BPE-500, A-BPE-4 (manufactured by Shin-Nakamura Chemical Co., Ltd.), and the like can be given.

Examples of commercially available products of compounds with structure according to the formula (2a) are BR-30 and BR-31 (manufactured by Dai-ichi Kogyo Seiyaku Co., Ltd.).

The compounds shown by the formulas (1a), (1b), or (2a) can be used either individually or in combinations of two or more Combined use of (1a) and (2a), (1b) and (2a), or (1a), (1b) and (2a) is preferable according to a balance between the refractive index and hardness of coating film.

The amount of compounds having the above formula (1) or (2) is preferably 20-90 wt %, and particularly preferably 30-80 wt % of the photocurable resin composition of the present invention. If less than 20 wt % of compound A is present, the effect of optical interference fringe removal from plastic sheets after coating and curing the photocurable resin composition and the effect of suppressing luminance decrease and color change when used as a plastic lens sheet may be insufficient. If more than 90 wt % of compound A is present, coatings have only low hardness and are easily impaired.

The photocurable resin composition has a refractive index after curing in the range of 1.56-1.65, and preferably in the range of 1.57-1.64. If the refractive index is less than 1.56 or more than 1.65, the optical inteference fringes of the plastic sheet cannot be removed. It is desirable that the difference between the refractive index of the photocurable resin composition of the present invention after curing and the refractive index of the substrate plastic sheet be within ±0.02, particularly within ±0.01.

The photocurable resin composition of the present invention preferably comprises, in addition to the component (A), which is a (meth)acrylate compound having three or more (meth)acryloyl groups in the molecule a component (B) and a photopolymerization initiator as a component (C).

Examples of the component (B) which is (meth)acrylate having at least three (meth)acryloyl groups in the molecule are compounds in which at least 3 mols of (meth)acrylic acid are bonded to a polyhydric alcohol having at least three hydroxy groups via an ester bond. Specific examples include trimethylolpropane tri(meth)acrylate, pentaerythritol tri(meth)acrylate, trimethylolpropanetrioxyethyl (meth)acrylate, tris(2-hydroxyethyl)isocyanurate tri(meth)acrylate, and diphentaerythritol hexa(meth)acrylate.

As commercially available products of the component (B), Viscoate #295, #300, #360, GPT, 3PA, #400 (manufactured by Osaka Organic Chemical Industry, Co., Ltd.), Light Acrylate TMP-A, PE-3A, PE-4A, DPE-6A (manufactured by Kyoeisha Chemical Co., Ltd.), KAYARAD PET-30, GPO-303, TMPTA, DPHA, D-310, D-330, DPCA-20, -30, -60, -120 (manufactured by Nippon Kayaku Co., Ltd.), ARONIX M-305, M-309, M-310, M-315, M-325, M-400 (manufactured by Toagosei Co., Ltd.), and the like can be given.

The proportion of the component (B) is preferably 5-40 wt %, and particularly preferably 10-35 wt % in the total composition. If the proportion of component (B) is less than 5 wt %, it is difficult to increase the glass transition temperature of the system, whereby the mechanical properties at high temperature may become insufficient. In addition, the coatings have a low hardness and tend to be easily damaged. If more than 40 wt %, the resin composition has a large contraction shrinkage when cured by light and tends to cause a substrate to warp when a coating film is formed.

Suitable examples of the photoinitiator (component (c)) are any compounds which dissolve and generate radicals upon irradiation to initiate the polymerization. Examples of such compounds include acetophenone, acetophenone benzyl ketal, 1 hydroxycyclohexyl phenyl ketone, 2,2-dimethoxy-2-phenylacetophenone, xanthone, fluorenone, benzaldehyde, fluorene, anthraquinone, tripohenylamine, carbazole, 3-methylacetophenone, 4 chlorobenzophenone, 4,4∝-dimethoxybenzophenone, 4,4′-diaminobenzophenone, Michler's ketone, benzoin propyl ether, benzoin ethyl ether, benzyl dimethyl ketal, 1(4-isopropylphenyl)-2-hydroxy-2-methylpropan-1-one, 2-hydroxy-2-methyl-1-phenylpropan-1 one, thioxanthone, diethyltioxanone, 2-isopropylthioxanthone, 2-chlorothloxanthone, 2-methyl-1-[4-(methylthio)phenyl]-2-morpholino-propan-1-one, 2,4,6-trimethylbenzoyl diphenylphosphine oxide, bis-(2,6 dimethoxybenzoyl)-2,4,4-trimethylpentylphosphine oxide, and oligo[2-hydroxy-2-methyl-1-[4-(1-methylvinyl)phenyl]propanone].

Of these compounds,1-hydroxycyclohexyl phenyl ketone, 2,2-dimethoxy-2-phenylacetophenone, 2-hydroxy-2-2-methyl-1-phenylpropan-1-one and oligo[2-hydroxy-2-methyl-1-[4-(1-methylvinyl)phenyl]propanone] are preferred in view of high curing speed and small coloration of cured coatings.

Examples of commercially available products of the photoinitiator are Irgacure 184, 369, 651, 500, 819, 907, 784, 2959, CGI1700, CGI1750, CGI11850, CG24-61, Darocur 1116, 1173 (manufactured by Ciba Specialty Chemicals Co., Ltd.), Lucirin TPO, TPO-L (manufactured by BASF). Ubecryl P36 (manufactured by UCB). Esacure KIP 150, KIP100F and KIP65LT (manufactured by Lamberti Co.).

The optimum amount of the photoinitiator to be added to cure the photocurable resin composition of the present invention is from 0.01 to 10 wt %, and preferably from 0.5 to 7 wt % of the total amount of the composition. If the amount exceeds 10 wt %, the curing characteristics of the composition, mechanical and optical properties and handling of the cured product may be adversely affected. If the amount is less than 0.01 wt %, the curing rate may decrease

As radiation used for curing the photocurable resin composition of the present invention, ionizing radiation such as infrared rays, visible rays, ultraviolet rays, X-rays, electron beams, α-rays, β-rays, γ-rays, and the like can be given.

A photosensitizer may be added to the resin composition of the present invention in addition to the photoinitiator. As examples of the photosensitizer, triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate, and the like can be given. As commercially available products of the photosensitizer, Ubecryl P102, 103, 104, and 105 (manufactured by UCB), and the like can be given.

A heat-polymerization initiator can be optionally added when curing the resin composition of the present invention. Peroxides and azo compounds can be given as examples of preferable heat-polymerization initiators. Specific examples include benzoyl peroxide, t-butyl peroxybenzoate, azobisisobutyronitrile, and the like.

Curable oligomers or polymers other than the above components may be added to the photocurable resin composition of the present invention insofar as the characteristics of the resin composition are not adversely affected. As examples of such other curable oligomers or polymers, polyurethane (meth)acrylate, polyester (meth)acrylate, epoxy (meth)acrylate, polyamide (meth)acrylate, siloxane polymers having a (meth)acryloyloxy group, and reactive polymers produced by reacting a copolymer of glycidyl methacrylate and other polymerizable monomer with (meth)acrylic acid can be given.

A dilution monomer or a solvent can be added to the photocurable resin composition of the present invention as required to adjust the viscosity of the composition. Given as specific examples of the dilution monomers are phenoxyethyl (meth)acrylate, phenoxy-2-methylethyl (meth)acrylate, phenoxyathoxyethyl (meth)acrylate, 3-phenoxy-2-hydroxypropyl (meth)acrylate, 2-phenylphenoxyethyl (meth)acrylate, 4 phenylphenoxyethyl (meth)acrylate, 3-(2-phenylphenyl)-2-hydroxypropyl (meth)acrylate, (meth)acrylate of a p-cumylphenol/ethylene oxide reaction product; vinyl monomers such as N vinylpyrrolidone, N-vinylcaprolactam, vinylimidazole, and vinylpyridine; isobornyl (meth)acrylate, bornyl (meth)acrylate, tricyclodecanyl (meth)acrylate, dicyclopentanyl (meth)acrylate, dicyclopentenyl (meth)acrylate, and cyclohexyl (meth)acrylate; benzyl (meth)acrylate, 4-butylcyclohexyl (meth)acrylate, acryloylmorpholine, 2-hydroxyethyl (meth)acrylate, 2-hydroxyproyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl(meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethylaminopropyl(meth)acrylamide, ethylene glycol di(meth)acrylate, tetraethylene glycol di(meth)acrylate, polyethylene glycol di(meth)acrylate, 1,4-butancdiol di(meth)acrylate, 1,6-hexanediol di(meth)acrylate, neopentyl glycol di(meth)acrylate, tris(2-hydroxyethyl)isocyanurate di(meth)acrylate, bis(hydroxymethyl)tricyclodecane di(meth)acrylate, and the like.

As examples of commercially available products of these monomers, ARONIX M-110, M-101, M-111, M-113, M-117, M-5700. TO-1317 (manufactured by Toagosei Co., Ltd.), Viscoat #192, #190, #160, #155, IBXA (manufactured by Osaka Organic Chemical Industry Co., Ltd.), NK Ester AMP-10G, AMP-20G, LA (manufactured by Shin-Nakamura Chemical Co., Ltd.). Light Acrylate PO-A, P-200A, EC-A, NP-EA, HOA-MPL, Epoxy Ester M-600A (manufactured by Kyoeisha Chemical Co., Ltd.), PHE, CEA, PHF-2, ME-3 (manufactured by Dai-ichi Kogyo Seiyaku Co., Ltd.). SR-339A, SR-504, SR-212, SR-213, KAYARAD TC 110S, R-128 (manufactured by Nippon Kayaku Co., Ltd.), FA-511A, 512A, 513A (manufactured by Hitachi formation industry company), VP (manufactured by BASF), ACMO, DMAA, DMAPAA (manufactured by Kojin Co., Ltd.), and the like can be given.

Any solvent can be used with the photocurable resin composition of the present invention inasmuch as the solvents do not interfere with the photocurability or reduce the hardness of the cured coatings. Given as specific examples of such solvents are hydrocarbons such as hexane, cyclohexane, heptane, octane, toluene, and xylene; alcohols such as methyl alcohol, ethyl alcohol, n-propyl alcohol, isopropyl alcohol, n-butyl alcohol, t-butyl alcohol, amyl alcohol, ethylene glycol, ethylene glycol monomethyl ether, propylene glycol, propylene glycol monomethyl ether, diethylene glycol, triethylene glycol, glycerol, and benzyl alcohol; ethers such as tetrahydrofuran, dimethoxyethane, ethylene glycol dimethyl ether, ethylene glycol diethyl ether propylene glycol dimethyl ether, propylene glycol diethyl ether, dioxane, and trioxane; esters such as ethyl acetate, butyl acetate, ethyl propionate, and ethyl lactate; and ketones such as acetone, methyl ethyl ketone, methyl isobutyl ketone, and cyclohexanone.

In addition to the above components, additives such as antioxidants, UV absorbers, light stabilizers, silane coupling agents, coating surface improvers, heat-polymerization inhibitors, leveling agents, surfactants, coloring agents, proscrivatives, plasticizers, lubricants, solvents, fillers, aging preventives, wettability improvers, and the like can be added to the photocurable resin composition of the present invention, as required. Examples of antioxidants include Irganox 1010, 1035, 1076, 1222 (manufactured by Ciba Speciality Chemicals Co., Ltd.), Antigene P, 3C, FR, Sumitizer S (manufactured by Sumitomo Chemical Industries Co., Ltd.), and the like. Examples of UV absorbers include Tinuvin P, 234, 320, 326, 327, 328, 329, 213 (manufactured by Ciba Speciality Chemicals Co., Ltd.). Seesorb 102, 103, 110, 501, 202, 712, 704 (manufactured by Shipro Kasei K. K.), and the like. Examples of light stabilizers include Tinuvin 292, 144, 622LD (manufactured by Ciba Specialty Chemicals Co Ltd.), Sanoi LS770 (manufactured by Sankyo Co., Ltd.), Sumisorb TM-061 (manufactured by Sumitomo Chemical Industries Co., Ltd.), and the like. Examples of silane coupling agents include

γ-aminopropyltriethoxysilane,

γ-mercaptopropyltrimethoxysilane,

γ-methacryloxypropyltrimethoxysilane, and commercially available products for example SH6062, 6030 (manufactured by Toray-Dow Corning Silicone Co., Ltd.), KBE903, 603, 403 (manufactured by Shin-Etsu Chemical Co., Ltd.). Examples of coating surface improvers include silicone additives such as dimethylsiloxane polyether, and commerically available products such as DC-57, DC-190 (manufactured by Dow Corning), SH-28PA, SH-29PA, SH-30PA, SH-190 (manufactured by Toray-Dow Corning Silicone Co., Ltd.), KF351, KF352, KF363, KF354 (manufactured by Shin-Elsu Chemical Co., Ltd.), L-700, L-7002, L-7500, FK-024 90 (manufactured by Nippon Unicar Co., Ltd.), and the like

Taking into account that the cured products of the photocurable resin composition of the present invention are used as plastic sheets or plastic lens sheets, it is desirable that such products have a pencil hardness of 2H or more, particularly 3H or more.

Stain-proof and damage-proof plastic sheets without optical interference fringes can be obtained by applying the photocurable resin composition to the surfaces of plastic sheets such as polystyrene, styrene-methyl methacrylate copolymer, polyethylene terephthalate, and polycarbonate, and curing the coating by radiation. Such a plastic sheet can be suitably sued as an exterior material for ornamental panels and furniture, and as a backlight optical material for liquid display devices as a plastic lens sheet exhibiting high luminance without change in color.

### EXAMPLES

The present invention will be explained in more detail by examples, which are not intended to be limiting of the present invention. Formulation in Table 1 means wt % of each component.

### Example 1

Synthetic

A reaction vessel equipped with a stirrer was charged with 1000 g of phenoxyethyl acrylate. 352.8 g of toluene diisocyanate, and 0.3 g of 2,6-di-t-butyl-p-cresol. The mixture was cooled to 5-10° C. When the temperature was lowered to 10° C. or less while stirring, 0.8 g of di-n-butyltin dilaurate was added and 235.2 g of hydroxyethyl acrylate was added dropwise. The mixture was sitrred for one hour while maintaining the liquid temperature at 20-30° C. Then, 412.1 g of polyoxyethylene-modified bisphenol A (molecular weight: 407) was added and the mixture was reacted for three more hours at 50 to 60° C. The reaction was terminated to confirm that the content of the residual isocyanate was 0.1 wt % or less. The urethane acrylate thus obtained is designated as UA-1. The viscosity of UA-1 at 25° C. was 3020 mPa·s.

### Examples 1-3 and Comparative Examples 1-2

Liquid photocurable resin compositions were prepared using the components in a proportion shown in Table 1.

### Evaluation Methods

Test specimens were prepared using the liquid photocurable resin compositions obtained in the examples according to the method described below. The viscosity, refractive index, transparency, and glass transition temperature of the test specimens were measured according to the following methods.

### Measurement of Viscosity

The viscosity at 25° C. was measured using a rotational viscometer according to JIS K7117.

### Measurement of Refractive Index

The photocurable resin composition was applied to a glass plate using an applicator bar and allowed to stand in an oven at 80° C. for three minutes. The coating was then exposed to ultraviolet rays using a 250 mW/cm² UV irradiation apparatus having a metal halide lamp as a light source at a dose of 1.0 J/cm² in air to form a cured film having a thickness of about 200 μm. The cured film was removed from the glass plate and conditioned at a temperature of 23° C. and a relative humidity of 50% for 24 hours to obtain a test specimen. The refractive index at 25° C. of the test specimen prepared above was measured using an Abbe's refractometer.

### Hardness

The photocurable resin composition was applied to a glass plate using an applicator bar and allowed to stand in an oven at 80° C. for three minutes. The coating was then exposed to ultraviolet rays using a 250 mW/cm² UV irradiation apparatus having a metal halide lamp as a light source at a dose of 1.0 J/cm² in air to form a cured film having a thickness of about 100 μm. The pencil hardness was measured with the cured film adhering to the glass plate, to determine the hardness of the cured resin.

### Observation of Interference Fringes

The photocurable resin composition was applied to a PET film processed for easy adhesion using a bar coater and allowed to stand in an oven at 80° C. for three minutes. The coating was then exposed to ultraviolet rays using a 250 mW/cm² UV irradiation apparatus having a metal halide lamp as a light source at a dose of 1.0 J/cm² in air to obtain a plastic sheet having a cured film with a thickness of about 200 μm.

The plastic sheet was placed on a sheet of black paper with the cured film up and irradiated with light using a three wavelength-type daylight white color fluorescence lamp (National Twin Two-parallel, FMI.27) to observe the surface of the plastic sheet. A sample plastic sheet with no interference fringe observed on the surface was rated as “AAA”, with slight interference fringes observed as “BBB”, and with clear interference fringes observed as “CCC”.

The components shown in Table 1 were as follows.

Component (A):

A-1: A compound with a methyl group for R¹, a hydrogen atom for R², a bromine atom for X¹, and an integer 2 for n in the formula (1a).

A-2: A compound with a methyl group for R¹, a hydrogen atom for R², a hydrogen atom for X¹, and an integer 3 for n in the formula (1a).

A 3: A compound with a methyl group for R¹, a hydrogen atom for R³, a hydrogen atom for X¹, and an integer 2 for m in the formula (1b) (Viscoat #700 manufactured by Osaka Organic Chemical Industry, Ltd.

A-4: A compound with a methyl group for R¹, a hydrogen atom for R³, a bromine atom for X¹, and an integer 1 for m in the formula (1b) (BR-42M manufactured by Dai-ichi Kogyo Seiyaku Co., Ltd.).

A-5: A compound with a hydrogen atom for R⁵ in the formula (2a) (BR 31 manufactured by Dai-ichi Kogyo Seiyaku Co., Ltd.).

Component (B):

B-1: Tris(acryloxyethyl)isocyanurate

B-2: Dipentaerythritol hexacrylate

B-3: Trimethylolpropane triscrylate

Component (C)

C-1: 1-Hydroxycyclohexyl penyl ketone

C-2: Oligo{2-hydroxy-2-methyl-1-[4-(1-methylvinyl)-phenyl]propanone}

Other Components:

UA-1: Urethane acrylate synthesized in Synthesis Example 1

PHE: Phenoxyethyl acrylate

ACMO: Acryloyl morpholine

MEK: Methyl ethyl ketone

MIBK: Methyl isobutyl ketone

| | | | | | | Comparative | |
|---|---|---|---|---|---|---|---|
| | Example | | | | | Example | |
| | 1 | 2 | 3 | 4 | 5 | 1 | 2 |
| Component A-1 | 20 | 23 | | 25 | 27 | | |
| A-2 | | | 10 | | | | 10 |
| A-3 | 8 | | | | | | |
| A-4 | | | 25 | | | | |
| A-5 | 25 | 25 | 20 | 39 | 30 | | |
| Component B-1 | 15 | 16 | | 8 | | | |
| B-2 | | 5 | 10 | | | 50 | 47 |
| B-3 | | | | 5 | | | |
| Component C-1 | 2 | 3 | 3 | | 3 | 3 | |
| C-2 | | | | 3 | | | 3 |
| Other component | | | | | | | |
| UA-1 | | 10 | 12 | | | | 20 |
| PHE | 10 | 10 | | 9 | 30 | 47 | 20 |
| ACMO | | 8 | | 11 | 10 | | |
| MEK | 10 | | 10 | | | | |
| MIBK | 10 | | 10 | | | | |
| Viscosity (mPa · s | 26 | 1450 | 40 | 1800 | 710 | 160 | 850 |
| 25° C.) | | | | | | | |
| Refractive index | 1.572 | 1.574 | 1.610 | 1.586 | 1.583 | 1.528 | 1.549 |
| Pencil hardness | 3H | 4H | 4H | 3H | 2B | 3H | 5H |
| Interference | AAA | AAA | AAA | AAA | AAA | CCC | BBB |
| fringes | | | | | | | |

As can be seen in Table 1, the photocurable resin compositions in which the components (A), (B), and (C) are incorporated had a refractive index between 1.56 and 1.65 without producing interference fringes. The composition is therefore useful as a stain-proof and damage-proof surface coating material without producing interference fringes when coated on the surfaces of plastic sheets such as polystyrene, styrene-methyl methacrylate copolymer, polyethylene terephthalate, and polycarbonate. Because the plastic lens sheet prepared using the photocurable resin composition of the present invention exhibits high luminance without change in color, the sheet is useful as a backlight optical material for liquid display devices.

### Effect of the Invention

A stain-proof and damage-proof plastic sheet without interference fringes can be obtained by using the photocurable resin composition of the present invention. Such a plastic sheet is useful as an exterior material for ornamental panels and furniture, and as a backlight optical material for liquid display devices as a plastic lens sheet exhibiting high luminance without change in color.

1. A photocurable resin composition suitable for forming a cured film on a plastic substrate, characterized in that the cured trim obtainable by photocuring the photocurable resin composition has a refractive index between 1,56 and 1,56.

2. The photocurable resin composition according to claim 1 wherein the photocurable resin composition comprises a component (A) which is chosen from a group comprising components having two (meth)acrylate groups and a divalent group shown by the following formula (1), 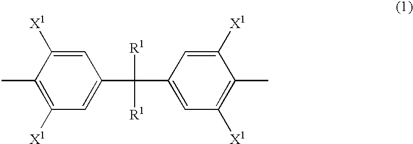
wherein R¹ independently represents a hydrogen atom or a methyl group, and X¹ independently represents a hydrogen atom, chlorine atom, or bromine atom, with the proviso that at least one X¹ is chlorine or bromine; and components having a (meth)acrylate group and a group shown by the following formula (2),

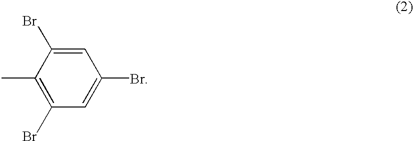

3. The photocurable resin composition according to claim 2, wherein the component (A) is at least one compound selected from a group consisting of the compound represented by the following formula (1a), 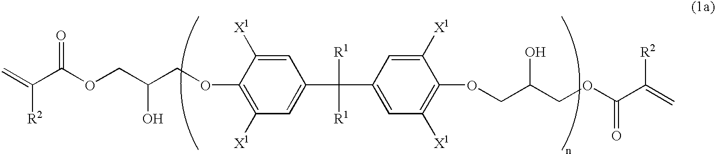
wherein R¹ and R² independently represent a hydrogen atom or a methyl group, n is an integer from 1 to 6, and X¹ independently represents a hydrogen atom, chlorine atom, or bromine atom with the proviso that at least one X¹ is chlorine or bromine,
the compound represented by the following formula (1b), 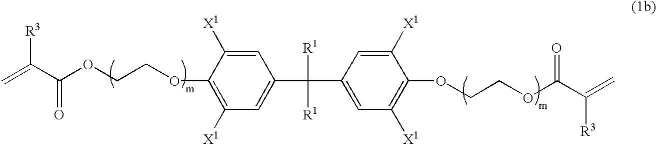
wherein R¹ and R³ independently represent a hydrogen atom or a methyl group, m is independently an integer from 1 to 6, and x¹ independently represents a hydrogen atom, chlorine atom, or bromine atom with the proviso that at least one X¹ is chlorine or bromine, and the compound represented by the following formula (2a), 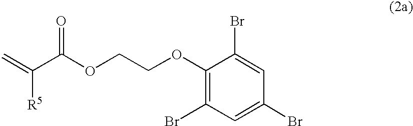
wherein R⁵ represents a hydrogen atom or methyl group.

4. The photocurable resin composition according to anyone of claims 1 to 3, further comprising (B) a (meth)acrylate compound having three or more (meth)acryloyl groups in the molecule and (C) a photopolymerization initiator.

5. The photocurable resin composition according to claim 4, containing 20-90 wt % of component (A), 5-40 wt % of component (B), and 0.01-10 wt % of component (C).

6. The photocurable resin composition according to any one of claims 1 to 5, wherein the cured products of the photocurable resin composition have a pencil hardness of 2H or harder.

7. A plastic sheet comprising a plastic substrate of which the surface is coated by the cured product of the photocurable resin composition according to any one of claims 1 to 6.

8. The plastic sheet according to claim 7, wherein the plastic substrate is a material selected from a group consisting of polystyrene, styrene-methyl methacrylate copolymer, polyethylene terephthalate, and polycarbonate

9. Use of othe photocurable composition as defined in anyone of claims 1-6 as a coating of a plastic sheet.
